(19) United States
(12) Patent Application Publication
(10) Pub. No.: US 2015/0073906 A1
(43) Pub. Date: Mar. 12, 2015

(54) METHOD AND SYSTEM FOR OPTIMIZING LOCATION-BASED TARGETED ADS SERVED ON A MOBLE DEVICE

(71) Applicant: MasterCard International Incorporated, Purchase, NY (US)

(72) Inventors: Rohit CHAUHAN, Somers, NY (US); Po Hu, Norwalk, CT (US)

(73) Assignee: MasterCard International Incorporated, Purchase, NY (US)

(21) Appl. No.: 14/022,741

(22) Filed: Sep. 10, 2013

(51) Int. Cl. G06Q 30/02; H04W 4/02

(52) U.S. Cl. CPC G06Q 30/0261; H04W 4/028; G06Q 30/0267
USPC 705/14.58

(57) ABSTRACT

A method for distributing an optimized offer to a mobile communication device includes: storing a plurality of offer data entries, each offer data entry including offer data and an offer location; storing a consumer profile, the consumer profile including historical geographic location data of a mobile communication device associated with the related consumer; receiving a geographic location of the associated mobile communication device; identifying at least one inferred future geographic location for the associated mobile communication device based on the received geographic location and the historical geographic location data; identifying at least one offer data entry where the included offer location corresponds to one of the identified at least one inferred future geographic location; and transmitting the offer data included in the identified at least one offer data entry to the associated mobile communication device.

### FIELD

The present disclosure relates to the distribution of optimized offers to a mobile device, specifically the optimization of offers based on identification of an inferred future geographic location based on a current location and a location history of the mobile device.

### BACKGROUND

With a large number of consumers carrying smart phones, merchants, manufacturers, retailers, offer providers, etc. have tried to develop ways to use consumer's smart phones to foster additional business. One method that has been developed includes distributing offers for nearby merchants to a consumer smart phone based on the geographic location of the smart phone. The goal of such an offer distribution is to entice the consumer to stop by a particular merchant based on the strength of the offer and the consumer's proximity to the merchant.

However, these methods often operate based purely on the current location of a consumer based on their mobile device. As a result, consumers may receive offers for products or merchants that the consumer has little interest in, which may further result in the consumer not being enticed to visit the merchant as a result of the offer. In order to attempt to further influence consumers, some systems have been developed that utilize consumer demographics or spending behaviors to select offers for nearby merchants that have a higher likelihood of success with a particular consumer.

However, many consumers who may receive these offers may typically follow a specific plan or routine when shopping. As such, these consumers may have no desire to remain in a particular location or visit an additional merchant nearby, even when provided with an offer to the nearby merchant. In addition, many consumers may also shop within specific budget constraints. Thus, even when presented with a beneficial offer, presenting the offer to the consumer once they are already spending an allotted amount may result in their rejecting of the offer due to the extra expense.

Thus, there is a need for a technical solution to distribute offers to consumers that are optimized not based purely on a consumer's current location, but based on an expected future location based on prior location history of the consumer.

### SUMMARY

The present disclosure provides a description of systems and methods for distributing an optimized offer to a mobile communication device.

A method for distributing an optimized offer to a mobile communication device includes: storing, in an offer database, a plurality of offer data entries, wherein each offer data entry includes data related to an offer for the purchase of goods or services including at least offer data and an offer location; storing, in a consumer database, a consumer profile, wherein the consumer profile includes data related to a consumer including at least historical geographic location data of a mobile communication device associated with the related consumer; receiving, by a receiving device, a geographic location of the associated mobile communication device; identifying, by a processing device, at least one inferred future geographic location for the associated mobile communication device based on the received geographic location and the historical geographic location data of the associated mobile communication device; identifying, in the offer database, at least one offer data entry where the included offer location corresponds to one of the identified at least one inferred future geographic location; and transmitting, by a transmitting device, the offer data included in the identified at least one offer data entry to the associated mobile communication device.

A system for distributing an optimized offer to a mobile communication device includes an offer database, a consumer database, a receiving device, a processing device, and a transmitting device. The offer database is configured to store a plurality of offer data entries, wherein each offer data entry includes data related to an offer for the purchase of goods or services including at least offer data and an offer location. The consumer database is configured to store a consumer profile, wherein the consumer profile includes data related to a consumer including at least historical geographic location data of a mobile communication device associated with the related consumer. The receiving device is configured to receive a geographic location of the associated mobile communication device. The processing device is configured to: identify at least one inferred future geographic location for the associated mobile communication device based on the received geographic location and the historical geographic location data of the associated mobile communication device; and identify, in the offer database, at least one offer data entry where the included offer location corresponds to one of the identified at least one inferred future geographic location. The transmitting device is configured to transmit the offer data included in the identified at least one offer data entry to the associated mobile communication device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for distributing optimized offers to a mobile device in accordance with exemplary embodiments.

FIG. 2 is a block diagram illustrating the processing server of FIG. 1 for the identification and distribution of optimized offers in accordance with exemplary embodiments.

FIGS. 3A and 3B are diagrams illustrating the identification of inferred future geographic locations of a mobile device in accordance with exemplary embodiments.

FIG. 4 is a diagram illustrating the identification of an optimized offer for distribution to a mobile device in accordance with exemplary embodiments.

FIG. 5 is a flow chart illustrating an exemplary method for distributing an optimized offer to a mobile communication device in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

### System for Distributing Optimized Offers to Mobile Devices

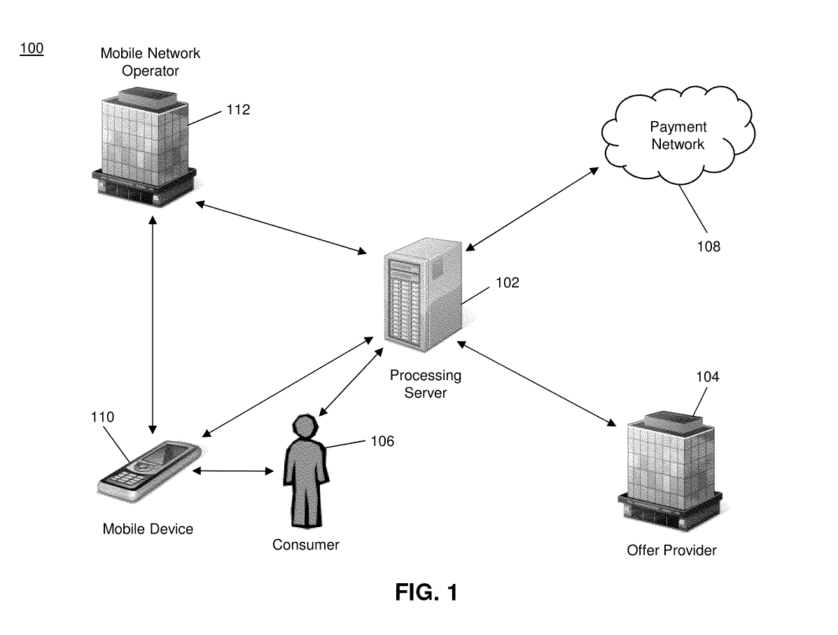

FIG. 1 illustrates a system 100 for the identification of optimized offers and distribution thereof to a mobile device based on historical and current geographic location data.

The system 100 may include a processing server 102. The processing server 102, discussed in more detail below, may be configured to identify optimized offers for a consumer based on a current geographic location of the consumer and historical location data of the consumer. The processing server 102 may receive one or more offers for distribution from an offer provider 104. The offer provider 104 may be a merchant, manufacturer, retailer, offer distribution, or any other entity suitable for performing the functions as disclosed herein.

Offers provided to the processing server 102 may be associated with a geographic location and include offer data. The offer data may include an offer amount, offer category, merchant name, merchant category, manufacturer name, manufacturer category, product name, product identifier, product data, offer identifier, offer type, start date, end date, offer quantity, offer terms and conditions, or any other data suitable for performing the functions as disclosed herein. The processing server 102 may receive the offers and store the offer data in an offer database, discussed in more detail below.

The processing server 102 may attempt to identify optimized offers to be distributed to a consumer 106. The consumer 106 may engage in a payment transaction with a merchant at a specific geographic location. The payment transaction may be processed by a payment network 108. The payment network 108 may transmit transaction data corresponding to the payment transaction to the processing server 102. The transaction data may include at least a geographic location associated with the payment transaction, which may be identified, for example, in an authorization request generated by a merchant involved in the payment transaction. The geographic location may thus represent the geographic location of the consumer 106 at the time of the transaction.

The processing server 102 may then identify one or more offers optimized for the consumer 106 based on the consumer's geographic location and historical geographic location data. The historical geographic location data may be based on a plurality of geographic locations of a mobile device 110 associated with the consumer 106. The mobile device 110 may be any type of mobile communication device suitable for performing the functions as disclosed herein as will be apparent to persons having skill with the relevant art, such as a cellular phone, smart phone, tablet computer, laptop computer, etc.

The geographic location data of the mobile device 110 may be provided to the processing server 102 by a mobile network operator 112 associated with the mobile device 110. The mobile network operator 112 may identify a geographic location of the mobile device 110 at a predetermined period of time (e.g., at a specific interval, when requested by the processing server 102, etc.) using systems and methods that will be apparent to persons having skill in the relevant art.

The processing server 102 may store the historical geographic location data in a consumer profile stored in a consumer database, discussed in more detail below. In some embodiments, the processing server 102 may request the location data upon receipt of the transaction data from the payment network 108. In other embodiments, the processing server 102 may have previously stored a consumer profile including historical geographic location data associated with the consumer 106. In a further embodiment, the processing server 102 may request updated geographic location information from the mobile network operator 112 prior to the identification of optimized offers.

In some instances, the processing server 102 may receive geographic location information directly from the mobile device 110. For example, the consumer 106 may register with the processing server 102 for a service to receive personalized, optimized offers. As part of the service, the consumer 106 may register the mobile device 110, which may report its geographic location to the processing server 102 at predetermined periods of time. Additional methods for obtaining historical geographic location data of the mobile device 110 will be apparent to persons having skill in the relevant art.

The processing server 102 may then use the historical geographic location data and current geographic location data to identify one or more inferred future geographic locations. As discussed in more detail below, the inferred future geographic locations may be estimated locations that the consumer 106 is expected to visit upon leaving their current geographic location. The processing server 102 may then identify offers corresponding to the inferred future geographic locations, and distribute the offers to the consumer 106 and/or the mobile device 110. Systems and methods for distributing offers to a consumer or a mobile device will be apparent to persons having skill in the relevant art.

In some embodiments, the processing server 102 may use action sequences to optimize the selection of offers. Action sequences, discussed in more detail below, may be a sequence of actions performed by a consumer, which may be used to identify an expected future action of a consumer. In some instances, action sequences may be specific to a particular consumer (e.g., the consumer 106) based on historical actions of the consumer 106. The historical actions of the consumer 106 may be based on transaction data, such as transaction data received from the payment network 108 and stored in a transaction database by the processing server 102, as discussed in more detail below.

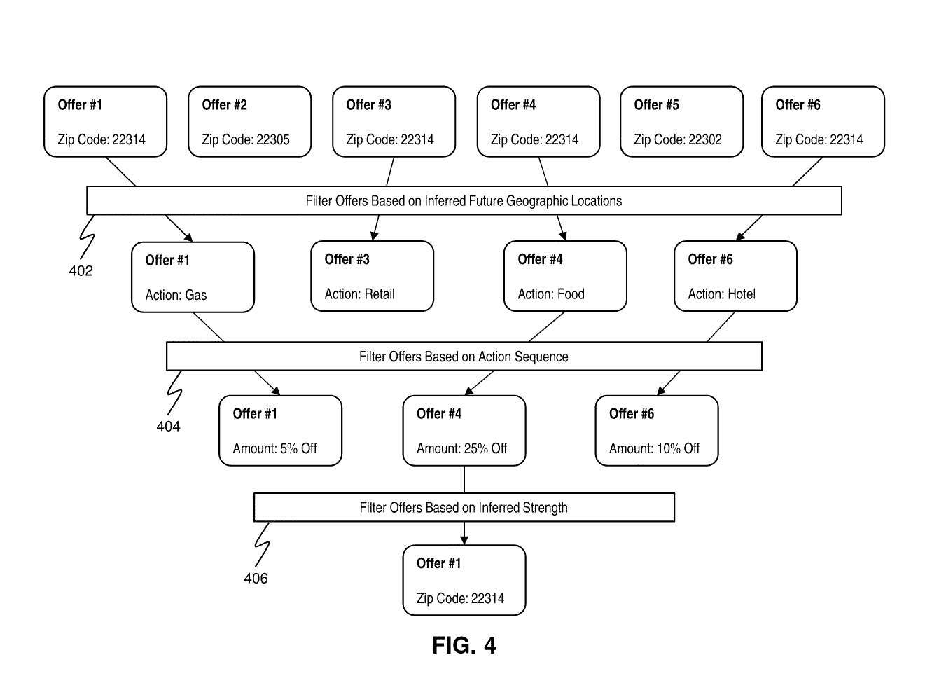

For example, an action sequence may established for when a consumer arrives in a new city via airport. An action sequence may be established where a consumer arrives at the airport, then rents a car or a taxi, then checks into a hotel, and then visits a restaurant. The processing server 102 may use an action sequence in conjunction with historical geographic location data to further optimize an offer distributed to the consumer 106. An example of the use of both historical geographic location data and action sequence data is illustrated in FIG. 4 and discussed in more detail below.

The use of historical geographic location data to optimize the identification and distribution of offers to a mobile device may result in the distribution of offers with a higher rate of redemption. By providing the consumer 106 with offers corresponding to where they are going to be, rather than where they are, the consumer 106 may be more enticed to visit a corresponding merchant. In addition, such offers may alter a consumer's itinerary, such as by influencing the consumer to shop at one store versus another yet still remain with a consumer's budget as such spending may not yet have occurred, resulting in a sale when there may otherwise not have been one.

Processing Device

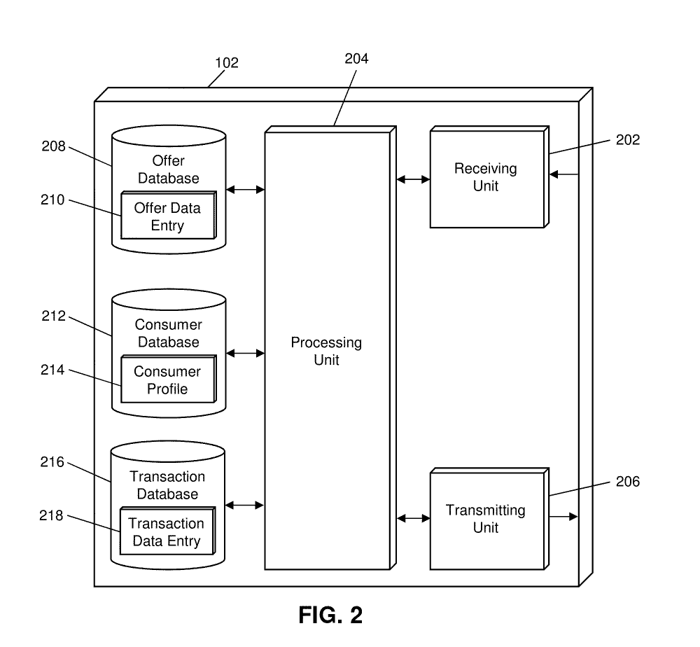

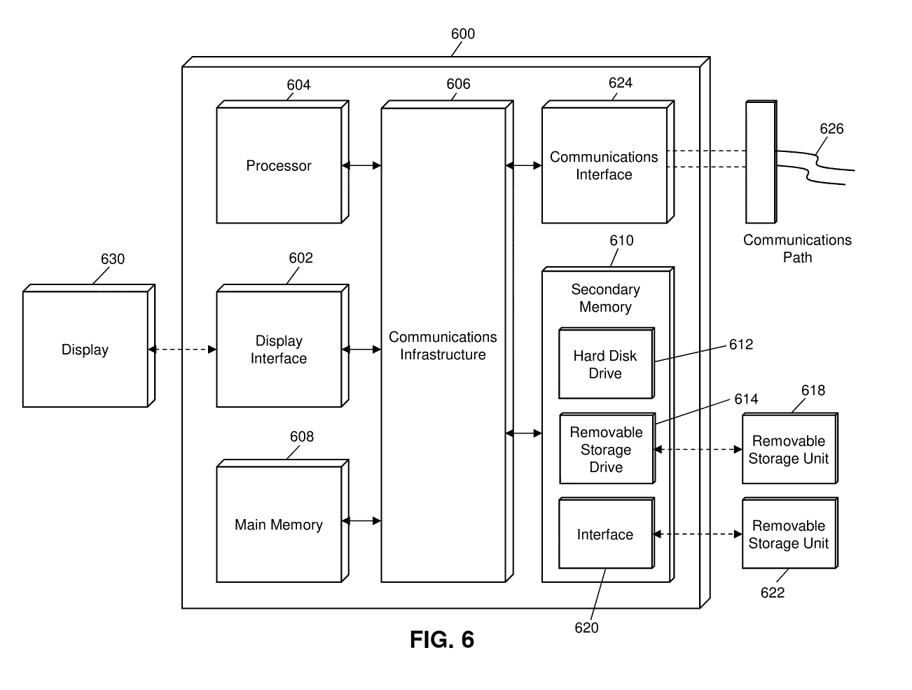

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols, such as the Internet, a mobile cellular network, etc. The receiving unit 202 may receive offer data from the offer provider 104, transaction data from the payment network 108, and geographic location data from the mobile network operator 112, mobile device 110, or other suitable entity.

The processing server 102 may also include a processing unit 204. The processing unit 204 may be configured to store received data in one or more databases. The processing server 102 may include an offer database 208, which may include one or more offer data entries 210, wherein each offer data entry 210 includes data related to an offer for the purchase of goods or services and includes at least offer data and an offer location. The offer location may be represented by latitude and longitude, a postal or zip code, street address, municipality, or any other suitable representation that will be apparent to persons having skill in the relevant art. In some embodiments, each offer data entry 210 may include an offer strength. The offer strength may be a value representative of the effect the offer has on a transaction amount when used. For example, an offer for $5 off a $50 item may have a lower offer strength than an offer for 20% off the same item.

The processing server 102 may also include a consumer database 212. The consumer database 212 may include one or more consumer profiles 214, wherein each consumer profile 214 includes data related to a consumer 106 including at least historical geographic location data of the mobile device 110 associated with the respective consumer 106. In some embodiments, the consumer profile 214 may also include merchant preferences, which may correspond to preferences the related consumer 106 may have for one merchant over another for use in optimizing distributed offers. In other embodiments, the consumer profile 214 may include one or more propensities to redeem, which may correspond to a propensity for the related consumer 106 to redeem an offer. Each propensity to redeem may be associated with at least one of: an offer category, merchant, offer type, offer value, offer strength, or other suitable criteria.

The consumer profile 214 may also include one or more consumer action sequences or associated consumer actions. The consumer action sequences may be action sequences specific to the related consumer 106. The associated consumer actions may be actions that are associated with a specific consumer action, similar to an action sequence. The consumer profile 214 may also include a preferred method of distribution. The preferred method of distribution may be a preferred method for the distribution of offers to the consumer 106 and/or the mobile device 110, such as short message service (SMS) message, multimedia message service (MMS) message, e-mail, etc.

The processing server 102 may also include a transaction database 216. The transaction database 216 may be configured to store a plurality of transaction data entries 218, wherein each transaction data entry 218 may include data related to a payment transaction including at least a consumer identifier and transaction data. The consumer identifier may be an identifier associated with a consumer profile 214 related to a consumer 106 involved in the related payment transaction. The transaction data may include any data corresponding to the related payment transaction suitable for performing the functions as disclosed herein, such as a transaction amount, merchant data, product data, geographic location, transaction time and/or date, redeemed offer data, etc.

In some embodiments, the processing server 102 may also include an action database. The action database may be configured to store a plurality of action sequence data entries, which may be related to an action sequence and include at least a consumer action and an inferred future consumer action. In some instances, each action sequence data entry may be associated with one or more consumer profiles 214. In some embodiments, an action sequence data entry may include multiple inferred future consumer actions. In a further embodiment, the multiple inferred future consumer actions may be weighted.

The processing unit 204 of the processing server 102 may be configured to utilize the data stored in the database to identify at least one inferred future geographic location for the consumer 106 and/or the mobile device 110. The at least one inferred future geographic location may be identified based on the current geographic location of the consumer 106 and the historical geographic location data stored in the consumer profile 214 related to the consumer 106. The processing unit 204 may then identify at least one offer data entry 210 in the offer database 208 wherein the included offer location corresponds to the at least one inferred future geographic location.

The processing server 102 may include a transmitting unit 206. The transmitting unit 206 may be configured to transmit data over one or more networks via one or more network protocols, including transmitting the offer data corresponding to the identified at least one offer data entry 210 to the consumer 106 and/or the mobile device 110. In some embodiments, the processing unit 204 may be configured to identify a single offer data entry 210 for transmission to the consumer 106 and/or the mobile device 110.

In such an embodiment, the processing unit 204 may identify the single offer data entry 210 based on offer strength, consumer merchant preferences, consumer propensities to redeem, consumer previous transaction history, consumer action sequence data, and/or action sequence data entries stored in the action database. The transmitting unit 206 may also distribute the at least one or single offer data entry 210 to the consumer 106 and/or mobile device 110 based on a preferred method of distribution in the corresponding consumer profile 214.

### Identification of Inferred Future Geographic Locations

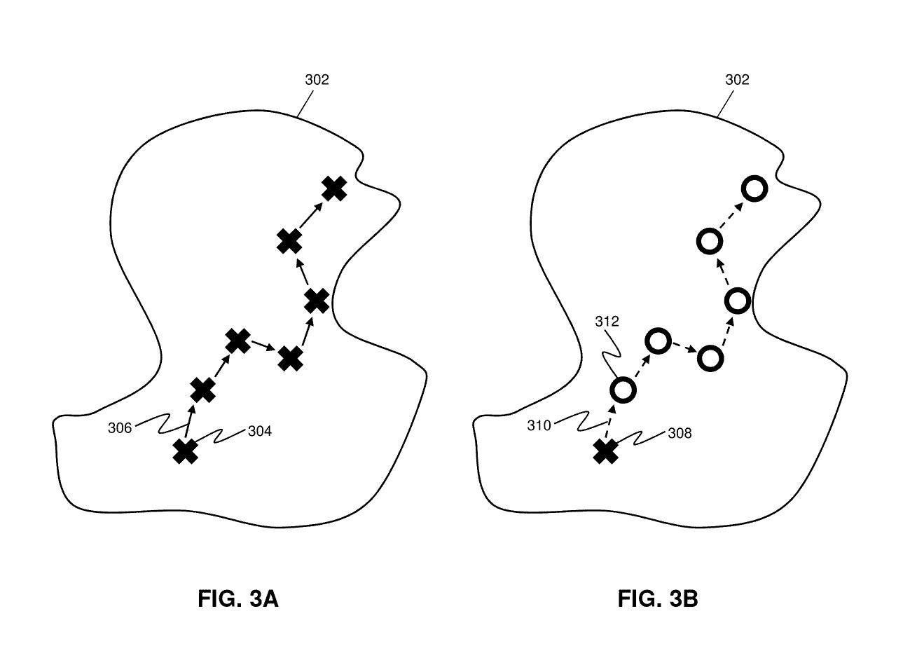

FIGS. 3A and 3B illustrate the identification of future geographic locations based on historical geographic location data.

As illustrated in FIG. 3A, the mobile device 110 of the consumer 106 may be identified at a plurality of geographic locations 304 in a geographic area 302. The geographic locations 304 may represent historical geographic location data of the consumer 106. The geographic locations 304 may be identified at predetermined periods of time related to: time intervals (e.g., every hour), changes in location (e.g., locations at which the mobile device 110 has stopped for a predetermined length of time), when payment transactions occur, etc.

Based on times at which the mobile device 110 is identified at each geographic location 304, the processing server 102 may identify a path 306 of the consumer 106. The path 306 may represent a path of travel of the consumer 106 based on the geographic locations 304. The processing server 102 may use the path 306, as well as the geographic locations 304, to identify inferred future geographic locations of the consumer 106.

As illustrated in FIG. 3B, the processing server 102 may identify a current geographic location 308 of the consumer 106, such as based on transaction data received from the payment network 108 or geographic location data received from the mobile network operator 112 and/or the mobile device 110. The processing server 102 may then identify an inferred path 310 based on the previous path 306 of the consumer leaving from the current geographic location 308. The processing server 102 may then identify a plurality of inferred future geographic locations 312 based on the inferred path 310 and the historical geographic location data.

### Optimization of Offers for Distribution

FIG. 4 illustrates the selection of an optimized offer for distribution to the consumer 106 based on consumer historical geographic location data.

The offer database 208 of the processing server 102 may store offer data entries 210 related to a plurality of offers, such as offers 1, 2, 3, 4, 5, and 6 illustrated in FIG. 4. Each of the offers may include an offer location, which is represented in FIG. 4 as a zip code associated with each offer. For example, offer 1 is associated with zip code 22314.

In step 402, the processing server 102 may filter the plurality of offers based on inferred future geographic locations of the consumer 106 based on the historical geographic location data of the consumer 106. As illustrated in FIG. 4, the processing server 102 may identify an inferred future geographic location of the consumer 106 to be in zip code 22314. As a result, the processing server 102 may filter out each of the offers not associated with zip code 22314, resulting in remaining offers 1, 3, 4, and 6.

Each of the remaining offers may also be associated with a specific consumer action. As illustrated offer 1 may be for gas, offer 3 may be for a retail store, offer 4 may be for a restaurant, and offer 6 may be for a hotel. The processing server 102 may, in step 404, filter the offers based on an action sequence. For example, the consumer 106 may have just traveled by air and arrived at an airport. The processing server 102 may identify action sequences including a consumer traveling by air to an airport or future inferred consumer actions following travel by air to an airport, to identify future actions that the consumer 106 may take. In some embodiments, the processing server 102 may identify action sequences for consumers in general, action sequences for the specific consumer 106, action sequences for similar consumers (e.g., having similar demographic characteristics or behaviors, etc.) or a combination thereof.

In the example illustrated in FIG. 4, the processing server 102 may identify getting gas (e.g., for a rental car or to fill up a car when returning home), eating, or visiting a hotel as actions commonly following arrival at an airport. The processing server 102 may identify visiting a retail store as not being a common action following arrival at an airport. As a result, in step 404 the processing server 102 may filter out offer 3, which may leave offers 1, 4, and 6 eligible for distribution to the consumer 106.

In step 406, the processing server 102 may use offer strength to select a single offer for distribution to the consumer 106. As illustrated in FIG. 4, offer 1 may be for 5% off, offer 4 may be for 25% off, and offer 6 may be for 10% off. Accordingly, the processing server 102 may identify offer 4 as being the strongest offer (e.g., and therefore potentially the most likely to be redeemed) and may identify offer 4 for distribution to the consumer 106.

It will be apparent to persons having skill in the relevant art that an offer with the highest percentage discount may not necessarily be the strongest offer. For example, 25% off at an inexpensive restaurant may represent a much smaller discount than 10% off an expensive hotel, and may, in some instances, be considered a weaker offer. In some embodiments, offer strengths may be weighted based on information included in the consumer profile 214. For example, the consumer 106 may have merchant preferences, action preferences, etc. In some instances, the processing server 102 may select, optimize, filter, etc. offers based on demographic information associated with the consumer 106. Methods and systems for further filtering or selecting an offer to be distributed to a consumer 106 will be apparent to persons having skill in the relevant art.

Additional criteria for offer strength may include season (e.g., higher strength for warm beverages in winter, higher strength for ice cream in summer, etc.), geographic area, overall redemption of the offer (e.g., of all consumers to whom the offer has been distributed), quantity of the offer (e.g., perceived rarity of the offer), availability period of the offer, popularity of an associated merchant or product, and other criteria that will be apparent to persons having skill in the relevant art. Weighting of offers may be performed after the filtering of offers, or may be combined with other methods of filtering, such as action sequences. For example, offers may have weights based on both the additional criteria and an action sequence (e.g., hotel offers may be weighed more heavily than restaurant offers following arrival at an airport), but an offer may be selected based on a combined weight, such that an offer with an abnormally high value for a restaurant may be selected over an offer for a hotel of a significantly lesser value.

### Method for Distributing an Optimized Offer to a Mobile Communication Device

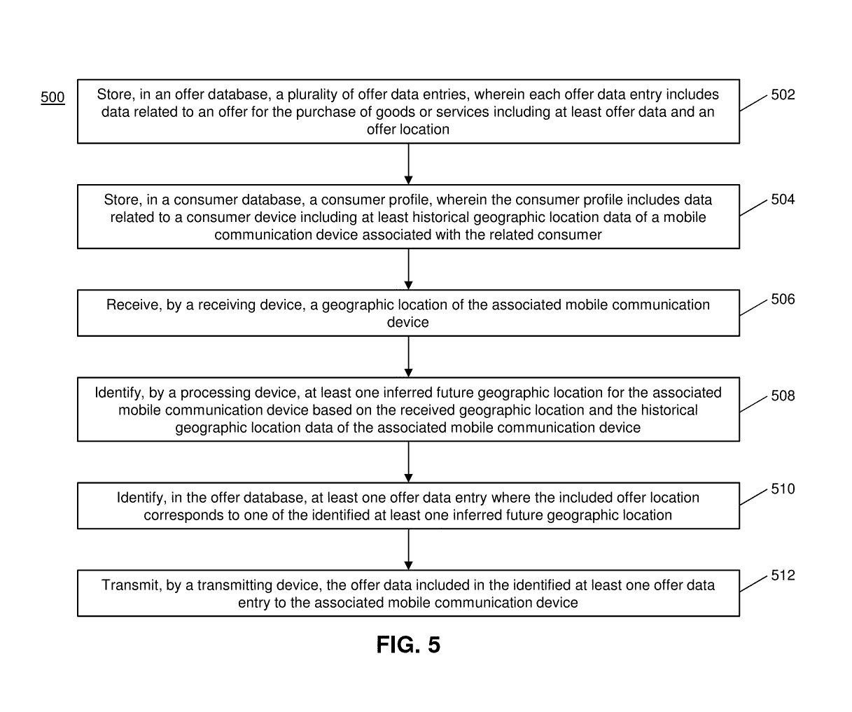

FIG. 5 illustrates a method 500 for distributing an optimized offer to a mobile device based on historical geographic location data.

In step 502, a plurality of offer data entries (e.g., offer data entries 210) may be stored in an offer database (e.g., the offer database 208), wherein each offer data entry 210 includes data related to an offer for the purchase of goods or services including at least offer data and an offer location. In some embodiments, the offer data may include at least one of: offer amount, offer category, merchant name, merchant category, manufacturer name, manufacturer category, product name, product identifier, product data, offer identifier, offer type, start date, end date, offer quantity, and offer terms and conditions.

In step 504, a consumer profile (e.g., the consumer profile 214) may be stored, in a consumer database (e.g., the consumer database 212), wherein the consumer profile 214 includes data related to a consumer (e.g., the consumer 106) including at least historical geographic location data of a mobile communication device (e.g., the mobile device 110) associated with the related consumer 106. In step 506, a geographic location (e.g., geographic location 308) of the associated mobile communication device 110 may be received by a receiving device (e.g., the receiving unit 202). In one embodiment, the geographic location may be represented by latitude and longitude.

In step 508, a processing device (e.g., the processing unit 204) may identify at least one inferred future geographic location (e.g., future geographic location 312) for the associated mobile communication device 110 based on the received geographic location 308 and the historical geographic location data of the associated mobile communication device 110. In some embodiments, the at least one future inferred geographic location may include a plurality of inferred future geographic locations corresponding to an identified inferred future path of travel.

In step 510, at least one offer data entry 210 may be identified, in the offer database 208, where the included offer location corresponds to one of the identified at least one inferred future geographic location 312. In one embodiment, the consumer profile 214 may include merchant preferences, each offer data entry 210 may further include a merchant category, and step 510 may include identifying at least one offer data entry 210 where the included merchant category corresponds to the merchant preferences. In some embodiments, each offer data entry 210 may further include an offer distance, and identifying the at least one offer data entry 210 may include identifying at least one offer data entry 210 where the included offer location is within the included offer distance of the identified at least one inferred future geographic location.

In step 512, the offer data included in the identified at least one offer data entry 210 may be transmitted, by a transmitting device (e.g., the transmitting unit 206), to the associated mobile communication device 110. In one embodiment, the consumer profile 214 may further include a preferred method of distribution, and transmitting the offer data may further include transmitting the offer data to the associated mobile communication device 110 via the preferred method of distribution. In a further embodiment, the preferred method of distribution is at least one of: SMS message, MMS message, e-mail, near field communication, and an application program executed by the associated mobile communication device 110.

In one embodiment, each offer data entry 210 may further include an offer strength, and the method 500 may further include identifying, by the processing device 204, a specific offer data entry 210 of the at least one offer data entry 210 based on the included offer strength, wherein transmitting the offer data to the associated mobile communication device 110 includes transmitting the offer data included in the identified specific offer data entry 210. In a further embodiment, the offer strength may be based on at least one of: discount amount, merchant category, offer availability, and product or service data.

In another embodiment, the consumer profile 214 may further include a plurality of propensities to redeem, each propensity to redeem being associated with one or more coupon categories, and wherein the method 500 further includes identifying, by the processing device 204, a specific offer data entry 210 of the at least one offer data entry 210 based on the included offer data and the plurality of propensities to redeem, wherein transmitting the offer data to the associated mobile communication device 110 includes transmitting the offer data included in the identified specific offer data entry 210.

In yet another embodiment, each offer data entry 210 may further include a corresponding consumer action, the received geographic location may further include an associated consumer action, and the method 500 may further include: storing, in an action database, a plurality of consumer action data entries, wherein each consumer action data entry includes at least a current consumer action and an inferred following consumer action; identifying, by the processing device 204, a specific offer data entry 210 of the at least one offer data entry 210 where the included corresponding consumer action corresponds to the inferred following consumer action included in the identified specific action sequence data entry, wherein transmitting the offer data to the associated mobile communication device 110 includes transmitting the offer data included in the identified specific offer data entry. In a further embodiment, the consumer action may include at least one of: transportation by train, transportation by air, transportation by boat, renting a car, purchasing gas, dining out, purchasing a hotel room, checking into a hotel, renting a taxi, and visiting an attraction.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 4 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for providing characteristic payments data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing an optimized offer to a mobile communication device, comprising:
storing, in an offer database, a plurality of offer data entries, wherein each offer data entry includes data related to an offer for the purchase of goods or services including at least offer data and an offer location;
storing, in a consumer database, a consumer profile, wherein the consumer profile includes data related to a consumer including at least historical geographic location data of a mobile communication device associated with the related consumer;
receiving, by a receiving device, a geographic location of the associated mobile communication device;
identifying, by a processing device, at least one inferred future geographic location for the associated mobile communication device based on the received geographic location and the historical geographic location data of the associated mobile communication device;
identifying, in the offer database, at least one offer data entry where the included offer location corresponds to one of the identified at least one inferred future geographic location; and
transmitting, by a transmitting device, the offer data included in the identified at least one offer data entry to the associated mobile communication device.

2. The method of claim 1, wherein each offer data entry further includes an offer strength, and the method further comprises:
identifying, by the processing device, a specific offer data entry of the at least one offer data entry based on the included offer strength, wherein
transmitting the offer data to the associated mobile communication device includes transmitting the offer data included in the identified specific offer data entry.

3. The method of claim 2, wherein the offer strength is based on at least one of: discount amount, merchant category, offer availability, and product or service data.

4. The method of claim 1, wherein
the consumer profile further includes merchant preferences,
each offer data entry further includes a merchant category, and
identifying the at least one offer data entry further includes identifying at least one offer data entry where the included merchant category corresponds to the merchant preferences.

5. The method of claim 1, wherein the consumer profile further includes a plurality of propensities to redeem, each propensity to redeem being associated with one or more offer categories, and wherein the method further comprises:
identifying, by the processing device, a specific offer data entry of the at least one offer data entry based on the included offer data and the plurality of propensities to redeem, wherein
transmitting the offer data to the associated mobile communication device includes transmitting the offer data included in the identified specific offer data entry.

6. The method of claim 1, wherein
each offer data entry further includes a corresponding consumer action,
the received geographic location further includes an associated consumer action,
and the method further comprises:
storing, in an action database, a plurality of action sequence data entries, wherein each action sequence data entry includes at least a current consumer action and an inferred following consumer action;
identifying, by the processing device, a specific action sequence data entry where the included current consumer action corresponds to the received associated consumer action; and
identifying, by the processing device, a specific offer data entry of the at least one offer data entry where the included corresponding consumer action corresponds to the inferred following consumer action included in the identified specific action sequence data entry, wherein
transmitting the offer data to the associated mobile communication device includes transmitting the offer data included in the identified specific offer data entry.

7. The method of claim 6, wherein the consumer action includes at least one of: transportation by train, transportation by air, transportation by boat, renting a car, purchasing gas, dining out, purchasing a hotel room, checking into a hotel, renting a taxi, and visiting an attraction.

8. The method of claim 1, wherein the offer data includes at least one of: offer amount, offer category, merchant name, merchant category, manufacturer name, manufacturer category, product name, product identifier, product data, offer identifier, offer type, start date, end date, offer quantity, and offer terms and conditions.

9. The method of claim 1, wherein the geographic location is represented by latitude and longitude.

10. The method of claim 1, wherein the at least one inferred future geographic location includes a plurality of inferred future geographic locations corresponding to an identified inferred future path of travel.

11. The method of claim 1, wherein each offer data entry further includes an offer distance, and identifying at least one offer data entry includes identifying at least one offer data entry where the included offer location is within the included offer distance of the identified at least one inferred future geographic location.

12. The method of claim 1, wherein the consumer profile further includes a preferred method of distribution, and transmitting the offer data further includes transmitting the offer data to the associated mobile communication device via the preferred method of distribution.

13. The method of claim 12, wherein the preferred method of distribution is at least one of: short message service (SMS) message, multimedia message service (MMS) message, e-mail, near field communication, and an application program executed by the associated mobile communication device.

14. A system for distributing an optimized offer to a mobile communication device, comprising:
an offer database configured to store a plurality of offer data entries, wherein each offer data entry includes data related to an offer for the purchase of goods or services including at least offer data and an offer location;
a consumer database configured to store a consumer profile, wherein the consumer profile includes data related to a consumer including at least historical geographic location data of a mobile communication device associated with the related consumer;
a receiving device configured to receive a geographic location of the associated mobile communication device;
a processing device configured to
identify at least one inferred future geographic location for the associated mobile communication device based on the received geographic location and the historical geographic location data of the associated mobile communication device, and
identify, in the offer database, at least one offer data entry where the included offer location corresponds to one of the identified at least one inferred future geographic location; and
a transmitting device configured to transmit the offer data included in the identified at least one offer data entry to the associated mobile communication device.

15. The system of claim 14, wherein
each offer data entry further includes an offer strength,
the processing device is further configured to identify a specific offer data entry of the at least one offer data entry based on the included offer strength, and
transmitting the offer data to the associated mobile communication device includes transmitting the offer data included in the identified specific offer data entry.

16. The system of claim 15, wherein the offer strength is based on at least one of: discount amount, merchant category, offer availability, and product or service data.

17. The system of claim 14, wherein
the consumer profile further includes merchant preferences,
each offer data entry further includes a merchant category, and
identifying the at least one offer data entry further includes identifying at least one offer data entry where the included merchant category corresponds to the merchant preferences.

18. The system of claim 14, wherein
the consumer profile further includes a plurality of propensities to redeem, each propensity to redeem being associated with one or more offer categories,
the processing device is further configured to identify a specific offer data entry of the at least one offer data entry based on the included offer data and the plurality of propensities to redeem, and
transmitting the offer data to the associated mobile communication device includes transmitting the offer data included in the identified specific offer data entry.

19. The system of claim 14, further comprising:
an action database configured to store a plurality of action sequence data entries, wherein each action sequence data entry includes at least a current consumer action and an inferred following consumer action, wherein
each offer data entry further includes a corresponding consumer action,
the received geographic location further includes an associated consumer action,
the processing device is further configured to
identify a specific action sequence data entry where the included current consumer action corresponds to the received associated consumer action, and
identify a specific offer data entry of the at least one offer data entry where the included corresponding consumer action corresponds to the inferred following consumer action included in the identified specific action sequence data entry, and
transmitting the offer data to the associated mobile communication device includes transmitting the offer data included in the identified specific offer data entry.

20. The system of claim 19, wherein the consumer action includes at least one of: transportation by train, transportation by air, transportation by boat, renting a car, purchasing gas, dining out, purchasing a hotel room, checking into a hotel, renting a taxi, and visiting an attraction.

21. The system of claim 14, wherein the offer data includes at least one of: offer amount, offer category, merchant name, merchant category, manufacturer name, manufacturer category, product name, product identifier, product data, offer identifier, offer type, start date, end date, offer quantity, and offer terms and conditions.

22. The system of claim 14, wherein the geographic location is represented by latitude and longitude.

23. The system of claim 14, wherein the at least one inferred future geographic location includes a plurality of inferred future geographic locations corresponding to an identified inferred future path of travel.

24. The system of claim 14, wherein each offer data entry further includes an offer distance, and identifying at least one offer data entry includes identifying at least one offer data entry where the included offer location is within the included offer distance of the identified at least one inferred future geographic location.

25. The system of claim 14, wherein the consumer profile further includes a preferred method of distribution, and transmitting the offer data further includes transmitting the offer data to the associated mobile communication device via the preferred method of distribution.

26. The system of claim 25, wherein the preferred method of distribution is at least one of: short message service (SMS) message, multimedia message service (MMS) message, e-mail, near field communication, and an application program executed by the associated mobile communication device.
